(19) United States
(12) Patent Application Publication
(10) Pub. No.: US 2007/0119717 A1
(43) Pub. Date: May 31, 2007

(54) Electrolytic production of solid Fe(VI) salts

(75) Inventor: Stuart Licht, Haifa (IL)

Correspondence Address: BROWDY AND NEIMARK, P.L.L.C.;624 NINTH STREET, NW, SUITE 300, WASHINGTON, DC, 20001-5303, US

(73) Assignee: CHEMERGY LTD., Technion City (IL)

(21) Appl. No.: 11/642,596

(22) Filed: Dec. 21, 2006

Related U.S. Application Data
(63) Continuation of application No. 10/089,050, filed on Sep. 27, 2002, now abandoned.

(30) Foreign Application Priority Data
Sep. 23, 1999 (IL) 132022

(51) Int. Cl. C25B 1/00

(52) U.S. Cl. 205/548

(57) ABSTRACT

The invention relates to a novel preparation of Fe(VI) salts, also known as Super-iron or ferrates, based on direct electrolytic synthesis into the solid-phase. According to the invention there are two half-cells which are in an electrochemical contact with one another through an electrically neutral ionic conductor, wherein one of said half-cells comprises a cathode and the other half cell comprises at least 1% by weight of an iron containing material, wherein a power supply is used to oxidize the iron containing material to a solid Fe(VI) salt.

The present invention relates to the novel preparation of Fe(VI) salts. More particularly the invention relates to a method for the preparation of Fe(VI) salts, also known as Super-iron or ferrates, based on direct electrolytic synthesis into the solid-phase.

### BACKGROUND OF THE INVENTION

There is an ongoing need for providing chemical oxidizing agents which are low-cost and are acceptable by the environment for a wide variety of applications including improved batteries, chemical synthesis and water purification. For example, for batteries, prima facie, salts containing iron in the +6 valence state, hereafter called Fe(VI) which are capable of multiple electron reduction, or multiple ion intercalation, would be capable to provide a higher cathode storage capacity.

Fe(VI) salts such as sodium, potassium and calcium/sodium ferrates, have been previously electrochemically formed by anodic dissolution which forms a solution containing dissolved Fe(VI). This has been reported by J. P. Deininger et. al. (U.S. Pat. Nos. 4,451,338, 4,435,257 and 435,256), and more recently by Devir et al. (J. App. Electrochem. 26, 823-827, 1996) and by Bouzek et al (Electrochem. Commun. 1, 370-374, 1999). Following this, solid Fe(VI) salts may be recovered by precipitation as a solid adduct.

Electrochemical synthesis by anodic dissolution has several unattractive features. These include that Fe(VI) is produced only in a highly dilute, and hence less useful, form. Typically Fe(VI) is synthesized by anodic dissolution only up to approximately 1% by weight, or less, of the solution. Another unattractive feature of anodic dissolution synthesis is the need for additional materials to recover by precipitation the solid Fe(VI) adduct. Still another unattractive feature of anodic dissolution synthesis is the loss of Fe(VI) during synthesis due to decomposition. This iron decomposition to a less oxidized form (i.e. to a lower valence state) can occur very rapidly. The stability of Fe(VI) salts solutions often being only on the order of a few hours at room temperature (Anal. Chem. 23, 1312-4, 1951). Later, in a report by H. Goff et al (J. Amer. Chem. Soc. 93, 6058-6065, 1971) it was mentioned that only little is known on the chemistry of Fe(VI) salts. The decomposition of iron to a lower valence, loses spontaneously the oxidative feature of the Fe(VI) salt. In its reaction with water the Fe(VI) as expressed in the form of the species FeO₄²⁻, such as from the salt K₂FeO₄ is unstable in neutral aqueous solutions and decomposes according to the following equation:
k_{f}
2FeO₄²⁻+3H₂O→2FeOOH+3/2O₂+4OH⁻ (1)

It is an object of the present invention to provide a novel method for electrochemical preparation of Fe(VI) salts which overcomes the unattractive features of anodic dissolution synthesis, and is therefore capable of producing concentrated Fe(VI), while also avoiding Fe(VI) decomposition losses during synthesis, and without the need for precipitating agents.

### BRIEF DESCRIPTION OF THE INVENTION

The invention relates to an electrochemical process to prepare solid Fe(VI) salts, by an electrolytic cell comprising two half-cells which are in an electrochemical contact with one another through an electrically neutral ionic conductor, wherein one of said half-cells comprises a cathode and the other half-cell comprises at least 1% of weight of an iron containing material, wherein a power supply is used to oxidize the iron containing material to a solid Fe(VI) salt. Material additions to the iron containing material, and to the electrically neutral ionic conductor can change the characteristics of the prepared solid Fe(VI) salt.

### BRIEF DESCRIPTION OF THE FIGURES

FIG. 1: is a diagrammatic illustration of an electrolytic process for preparing solid Fe(VI) salts.

### DETAILED DESCRIPTION OF THE INVENTION

The novel battery according to the present invention is based on Fe(VI) (hereafter also called “super iron”) half cell in contact with a cathode half cell through an electrically neutral ionic conductor. The preparation of this solid super iron salt is based on the electrolytic oxidation of a half cell containing at least 1% by weight of iron in its 0 (metal or Fe(0)), and/or +2 (Fe(II)), and/or +3 (Fe(III) valence state. The electrically neutral ionic conductor has a Fe(VI) salt dissolving capacity less than the quantity of prepared Fe(VI) salt. This undissolved prepared Fe(VI) salt is in the solid phase. This overcomes the unattractive features of anodic dissolution synthesis, and is capable of producing more concentrated Fe(VI), which avoids solution phase Fe(VI) decomposition losses during synthesis, and which is formed without the need for precipitating agents.

The solid Fe(VI) salt is illustrated by MFeO₄, M being an alkali earth cation. Other typical examples includes a cation, selected from the alkali cations, in the form M₂FeO₄, or from the group consisting of the transition metal cations, or containing, cations of group III, group IV and group V elements, with charge +z, and of the form M_{2/z}FeO₄. Similarly Fe(VI) salts in addition to oxygen, can contain hydroxide and/or other anions, X, of charge −y, and of the generalized form: M_{2/z}FeX_{8/y}. The anion, X, include, but are not limited to: hydroxides, acetates, acetylsalicylates, alumminates, aluminum hydrides, amides, antomonides, arsenates, azides, benzoates, borates, bromides, bromates, carbides, carbonates, chlorates, perchlorates, chlorides, hypochlorites, chlorites, dithiones, chloroplatinates, chromates, citrates, fluorides, fluosilicates, fluosulfonates, formates, gallium hydrides, gallium nitrides, germanates, hydrides, iodates, iodides, periodate, laurates, manganates, malonates, permanganates, molybdates, myristates, nitrates, nitrides, nitrites, oxalates, oxides, palmitates, phosphates, salicylates, selenates, selenides, silicates, suicides, stearates, succinates, sulfates, sulfides, sulfites, tartrates, thiocyanates, thionates, tungstates, halides, or chalcogenides. Additionally, each Fe(VI) salts can contain n water or other solvent molecules, W of the generalized form, not limited to: M_{2/z}FeX_{8/y}.Wₙ.

Examples thereof include, but are not limited to, K₂FeO₄, Na₂FeO₄, Li₂FeO₄, Cs₂FeO₄, Rb₂FeO₄, H₂FeO₄, (NH₄)₂FeO₄, BeFeO₄, MgFeO₄, CaFeO₄, SrFeO₄, BaFeO₄, BaFeO₄.H₂O, BaFeO₄.2H₂O, Hg₂FeO₄, HgFeO₄, Cu₂FeO₄, CuFeO₄, ZnFeO₄, Ag₂FeO₄, FeFeO₄, Fe₂(FeO₄)₃, MnFeO₄, NiFeO₄, CoFeO₄, Al₂(FeO₄)₃, In₂(FeO₄)₃, Ga₂(FeO₄)₃, SnFeO₄, PbFeO₄, Sn(FeO₄)₂, Pb(FeO₄)₂.

Without being bound to any theory, the electrolytic oxidation of iron in its 0 (Fe(0)), +2 (Fe(II)) or +3 (Fe(III)) valence state, requires per iron a minimum electrolysis charge (current x time) sufficient to release 6, 4, or 3 electrons, respectively, in accord with:
Fe(0)→Fe(VI)+6e⁻ (2)
Fe(II)→Fe(VI)+4e⁻ (3)
Fe(III)→Fe(VI)+3e⁻ (4)
3Fe(8/3, as in Fe₃O₄)→3Fe(VI)+10e⁻ (5)
Generally the electrolysis charge time depends on the desired final FeO₄²⁻concentration.

The Fe(0) in the half-cell is iron metal, in a typical embodiment of high surface area which includes iron powder, iron wire, iron screen or roughened iron surfaces or in another typical embodiment sheet or solid iron. The iron salt used in the synthesis in the half-cell is in the solid or dissolved state. Fe(II) salts includes, but are not limited to FeO, Fe(OH)₂, and salts of the general form M_{z}Fe(II)X_{y}.Wₙ. which contains z or one or more cations, M, and y of one or more cations X, and n of on or more solvent molecules W. The Fe(III) salt includes, but is not limited to Fe₂O₃, FeOOH, Fe(OH)₃, and salts of the general form M_{z}Fe(III)X_{y}.Wₙ. which contains z or one or more cations, M, and y of one or more cations X, and n of on or more solvent molecules W. Alternately, a salt of intermediate valence, such as Fe₃O₄, can be used as the iron salt.

The iron (Fe(0), Fe(II) or Fe(III)) which is to be oxidized is placed in contact with a conductive material, such as graphite, carbon black or a metal. These and other agents can be formed by mixing with the iron as a powder, and the powder can be pressed with these and other agents to improve mechanical strength. Rather than mixing with a conductive material, the iron salt can be placed in direct contact with a conductive material. These conductive materials include, but are not limited to a planar conductive surface, a wire, a porous conductive substrate or a conductive grid.

The cathode of the battery may be selected from the known list of materials capable of being reduced, typical examples being metal and non-metal inorganic salts, and organic compounds including aromatic and non-aromatic compounds.

The electrically neutral ionic conductor utilized in the battery according to the present invention, comprises a medium that can support current density during battery discharge. Typical representative ionic conductor is an aqueous solutions preferably containing a high concentration of a hydroxide such as KOH.

In typical embodiments, the electrically neutral ionic conductor comprises common ionic conductor materials used in electrolytic processes which include, but are not limited to an aqueous solution, a non-aqueous solution, a conductive polymer, a solid ionic conductor and a molten salt.

According to another embodiment, the invention provides means to impede transfer of chemically reactive species, or prevent electric contact between the anode and Fe(VI) salt cathode. Said means includes, but is not limited to a membrane a ceramic frit, or agar solution, positioned to separate said half cells or a non-conductive separator configured with open channels, grids or pores.

A material addition, from 0.1 to 50%, and in the preferred range from 1 to 10%, to the electrically neutral ionic conductor, or to the iron in its 0, +2 or +3 valence state, can modify the quantity and the physical, chemical and electrochemical characteristics of the Fe(VI) salt which will be formed, and or modify the voltage and coulombic efficiency of the Fe(VI) electrolytic formation process. A material addition of a barium compound, can be used to decrease the solubility of Fe(VI) salts to improve the quantity of Fe(VI) salt produced. Barium additions include, but are not limited to, barium(II) compounds, as illustrated by BaX₂ and BaY₃, where X and Y are anions as previously described.

A material addition of an oxygen containing compound, be used to increase quantity of Fe(VI) salt produced. Oxygen containing compounds include, but are not limited to, hydroxide compounds, such as MOH compounds, M being an alkali cation. Another typical example of hydroxides salts contain alkali earth, M′ cations, other typical examples includes a cation, selected from the group consisting of the transition metal cations, or containing, cations of group III, group IV and group V elements. Another typical example of oxygen containing compounds includes oxides containing alkali, alkali earth, M′ cations, or a cation, selected from the group consisting of the transition metal cations, or containing, cations of group III, group IV and group V elements.

A material addition of a manganese compound, can be used. Manganese additions include, but are not limited to, manganese(IV) compounds, as illustrated by MnO₂, Mn(OH)₄, MnO₂, or MnS₂, manganese(III) salts, as illustrated by Mn₂O₃, and Mn(OH)₃, and Mn(II) salts, as illustrated by MnO, and Mn(OH)₂. Other typical manganese additions are manganese(VII) compounds illustrated by a permanganate salt MMnO₄, or Mn₂O₇, or manganese(VI) compounds illustrated by manganate salt, M₂MnO₂, M being an alkali cation. Another typical example of manganate and permanganate salts contain alkali earth, M′ cations, other typical examples includes a cation, selected from the group consisting of the transition metal cations, or containing, cations of group III, group IV and group V elements.

A material addition of a cobalt compound can be used. Cobalt additions include, but are not limited to, cobalt(III) compounds, as illustrated by Co₂Y₃, or CoX₃, Y being oxygen or in other typical examples being a chalcogenide, chromate, molybdate, silicate, malonate, succinate, tartrate, selenate, sulfate, or sulfite anions. X being a hydroxide anion, or in other typical examples, X being a halide anion, nitrate, bromate, chlorate, perchlorate, acetate, oxalate, carbonate, benzoate, hypochlorite, chlorite, dithionate, formate, iodate, or periodate anions. Other typical cobalt additions are Co(II) compounds such as CoY, CoX₂ and Co(IV) compounds such as and CoY₂, and CoX .

A material addition of lithium containing compound, can be used. Lithium containing compounds include, but are not limited to lithium: hydroxides, carbonates, acetates, acetylsalicylates, alumminates, aluminum hudrides, amides, antomonides, arsenates, azides, benzoates, borates, bromides, carbides, chlorates, perchlorates, chlorides, chloroplatinates, chromates, citrates, fluorides, fluosilicates, fluosulfonates, formates, gallium hydrides, gallium nitrides, germanates, hydrides, iodates, iodides, laurates, manganates, permanganates, molybdates, myristates, nitrates, nitrides, nitrites, oxalates, oxides, palmitates, phosphates, salicylates, selenides, silicates, suicides, stearates, sulfates, sulfides, sulfites, tartrates, thiocyanates, thionates, tungstates, or a material capable of incorporating the lithium ions, including but not limited to a carbon based material, or a tin based material, or a lithium intercalating material.

A material addition of various salts can be used to alter the required electrolysis voltage and/or alter the characteristics of the produced Fe(VI) salt. These compounds include indium compounds, which can lower the required electrolysis voltage, tin compounds, such as SnO, and SnO₂, tungsten compounds, such as WO₃, and WO₂, and cobalt compounds, such as CoO and Co₂O₃. Indium additions include, but are not limited to, indium(III) compounds, as illustrated by In₂Y₃, or InX₃, where X and Y are previously described. Other typical indium additions are In(II) compounds as InY, InX₂ and In(IV) compounds such as and InY₂, and InX₄.

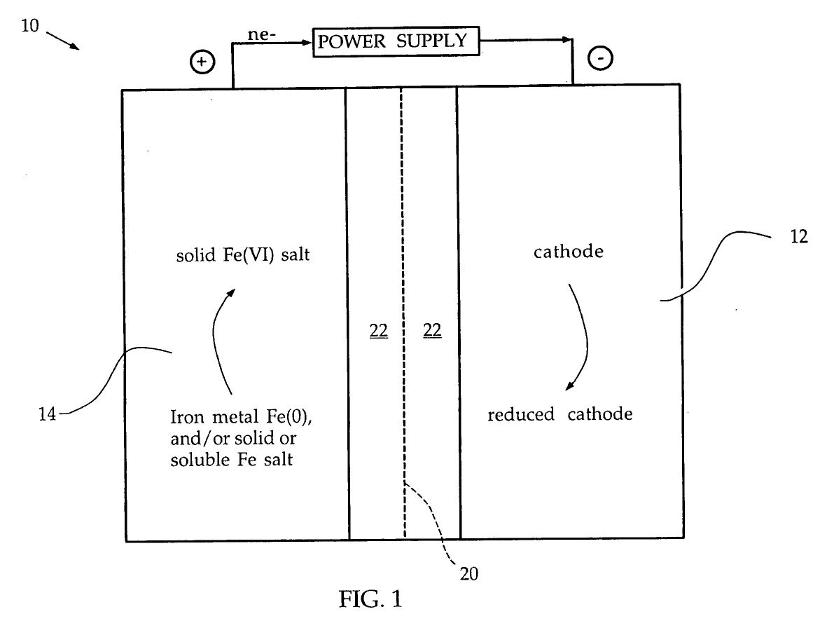

### DETAILED DESCRIPTION OF FIG. 1

FIG. 1 illustrates schematically an electrochemical cell (10) based on an Fe(0), Fe(II) or Fe(III) half cell, an electrically neutral ionic conductor and an cathode. The cell contains an electrically neutral ionic conductor (22), such as a concentrated aqueous solution of KOH or Ba(OH)₂, or a non-aqueous solution containing a lithium salt, in contact with an Fe(0), Fe(II) or Fe(III) anode (14), typically a Fe(III) salt as a pressed pellet containing conductive powder, typcially carbon black, and generating an Fe(VI) salt such as BaFeO₄, K₂FeO₄, or Li₂FeO₄ during the synthesis. Oxidation of Fe(0), Fe salts is achieved via electrons removed by the power supply (14) to form the solid Fe(VI) salt. The cathode electrode 12, receives this electrons, such as in the form of a metal salt, is also in contact with the electrically neutral ionic conductor (22). Electrons are released in the oxidation of the anode. Optionally, the cell may contain an ion selective membrane or non-selective membrane (20) as a separator, for minimizing the non-electrochemical interaction between the cathode and the anode.

The invention will be hereafter illustrated by the following Examples, being understood that the Examples are presented only for a better understanding of the invention without implying any limitation thereto, the invention being covered by the appended Claims.

### EXAMPLE 1

An experiment was carried out, the object being to determine electrically neutral ionic conductors which have a limited Fe(VI) salt dissolving capacity, and which are thereby in a cell are compatible to produce solid Fe(VI) salt. For a cell containing a volume, V, of solution, the maximum dissolving capacity is V×S. S is the maximum solubility of the Fe(VI) salt in various electrically neutral ionic conductors. A lower value of S will increase the fraction of produced Fe(VI) which is in the solid state. A very low value of S will determine that the significant majority of produced Fe(VI) salt is in the solid state. A variety of solutions can be used as electrically ionic conductors. Table 1 presents the measured solubility of two examples of Fe(VI) salts, BaFeO₄ and K₂FeO₄, in a variety of solutions. As seen in Table 1, each of these solutions has a limited solubility of Fe(VI) salt and can be used to produce solid Fe(VI) salt when it is formed in a quantity greater than the limited dissolving capacity.

TABLE 1
Examples of the dissolving capacity of various
aqueous and non-aqueous solutions for Fe(VI) salts, as
expressed by the solution solubility; where for a cell
containing a volume, V, of solution, the dissolving capacity
is V x the Solubility. LiClO₄, LiTFB, LiTFMS refers to 1M,
molar in lithium perchlorate, or 1M in lithium
tetrafluoroborate, or 1M lithium tetrafluoromethane sulfonate.

| Solution | Salt | S, Solubility | |
|---|---|---|---|
| water | BaFeO₄ | <<10⁻⁵ | M |
| aqueous 0.2 M Ba(OH)₂ | BaFeO₄ | <<10⁻⁵ | M |
| aq. 5 M KOH & satd Ba(OH)₂ | BaFeO₄ | <2 × 10⁻⁴ | M |
| aq. 5 M KOH & satd Ba(OH)₂ | K₂FeO₄ | <2 × 10⁻⁴ | M |
| aq. 5 M KOH | BaFeO₄ | 5 × 10⁻⁴ | M |
| aq. 5 M KOH | K₂FeO₄ + Ba(OH)₂ | 5 × 10⁻⁴ | M |
| aq. 5 M KOH | K₂FeO₄ | 7 × 10⁻² | M |
| aq. 5 M LiOH | K₂FeO₄ | 9 × 10⁻¹ | M |
| aq. 5 M NaOH | K₂FeO₄ | 1.4 | M |
| aq. 5 M CsOH | K₂FeO₄ | 3.5 × 10⁻² | M |
| aq. 10 M NaOH | K₂FeO₄ | 5 × 10⁻¹ | M |
| aq. 10 M KOH | K₂FeO₄ | 1 × 10⁻² | M |
| aq. satd. KOH | K₂FeO₄ | 2 × 10⁻³ | M |
| acetonitrile (ACN) | BaFeO₄, K₂FeO₄ | <<10⁻⁵ | M |
| ACN LiClO₄, LiTFB, LiTFMS | BaFeO₄, K₂FeO₄ | <<10⁻⁵ | M |
| Propylene carbonate (PC) | BaFeO₄, K₂FeO₄ | <<10⁻⁵ | M |
| PC LiClO₄, LiTFB, LiTFMS | BaFeO₄, K₂FeO₄ | <<10⁻⁵ | M |
| acetone | BaFeO₄, K₂FeO₄ | <<10⁻⁵ | M |
| hexane | BaFeO₄, K₂FeO₄ | <<10⁻⁵ | M |
| chloroform | BaFeO₄, K₂FeO₄ | <<10⁻⁵ | M |
| sulfonane | BaFeO₄, K₂FeO₄ | <<10⁻⁵ | M |
| 1,4-dioxane | BaFeO₄, K₂FeO₄ | <<10⁻⁵ | M |
| ethylene carbonate (EC) | BaFeO₄, K₂FeO₄ | <<10⁻⁵ | M |
| EC + 0.5 M LiClO₄ | BaFeO₄, K₂FeO₄ | <<10⁻⁵ | M |
| γ-butyrlactone (BLA) | BaFeO₄, K₂FeO₄ | <<10⁻⁵ | M |
| BLA + 0.5 M LiClO₄ | BaFeO₄, K₂FeO₄ | <<10⁻⁵ | M |
| tetrahyrofuran (THF) | BaFeO₄, K₂FeO₄ | <<10⁻⁵ | M |
| THF + 1 M LiClO₄ | BaFeO₄, K₂FeO₄ | <<10⁻⁵ | M |
| Dimethoxyethane (DME) | BaFeO₄, K₂FeO₄ | <<10⁻⁵ | M |
| DME LiClO₄, LiTFB, LiTFMS | BaFeO₄, K₂FeO₄ | <<10⁻⁵ | M |
| Dimethylformamide (DMF) | BaFeO₄, K₂FeO₄ | <<10⁻⁵ | M |
| DMF + 1 M LiTFMS | BaFeO₄, K₂FeO₄ | <<10⁻⁵ | M |
| Dimethylsulfoxide (DMSO) | BaFeO₄, K₂FeO₄ | <<10⁻⁵ | M |
| DMSO + 1 M LiClO₄ | BaFeO₄, K₂FeO₄ | <<10⁻⁵ | M |

### EXAMPLE 2

An experiment was carried out, the object being to produce electrolytic solid Fe(VI) salt using an electrochemical cell as diagrammatically illustrated in FIG. 1. The electrochemical cell configuration consisted of a 2 cm diameter button cell comprised of an upper (cathode) section, pressing onto a mid (separator) section, pressing onto a lower (anode) section.

The upper section of the electrochemical cell configuration comprises an upper inverted metal dish plate (the cathode cap) pressing onto a metal washer type spring, which presses onto a metal screen (the cathode collector), pressing onto a metal hydride material removed from a discharge commercial metal hydride battery. The quantity of metal hydride is determined to be in coulombic excess of the iron starting material, as determined in accord with equations 2-5. The mid section consists of a separator material removed from a commercial metal hydride battery and is surrounded by a PTFE washer to prevent direct contact or electrical shorting of the upper and lower section. Various electrolytes as electrically neutral ionic conductors, in various amounts, were tested, and are added to the separator and anode material. The lower section consists of a pressed mixed powder pressed into a bottom metal dish plate. Various cells were formed with powders containing a variety of iron materials in the Fe(0), Fe(II), or Fe(III) valence state, as well as various tested additives and added conductors.

An oxidizing current was applied to the anode using a constant current power supply connected for a fixed time to the upper and lower plates of the electrochemical cell configuration. A variety of currents and times were examined in various cells. Each cell was then opened, and the solid iron material was removed. The percentage of the original iron containing material that was converted to solid Fe(VI) salt was determined by the chromite method to probe the iron valence state, determined by Fe(VI) redissolution as FeO₄²⁻, and oxidation of chromite, according to (where chromate generated is titrated with a standard ferrous ammonium sulfate solution, using a sodium diphenylamine sulfonate indicator):
Cr(OH)₄—+FeO₄²⁻+3H₂O→Fe(OH)₃(H₂O)₃+CrO₄²⁻+OH⁻ (6)

Tables 2-4 summarizes the percentage of Fe(VI) salt that was produced from the original iron containing material for a variety of formed electrolytic cells. As can be seen in the tables, various solid Fe(VI) salts can be directly formed by this procedure, and this procedure varies with added conductor, additives, electrolyte and electrolysis time and current. In each case of the experiments summarized in Tables 2-4, 25 mAh of an iron material as determined by equation 2, 3, 4 or 5. is used as the synthesis starting material In the tables for the anode mix, the molar ratio of any additive is indicated, as well the percent by weight of the conductor. Also in the Table, Ba(OH)₂ represents Ba(OH)₂.8H₂O, 13.5KB represents 13.5 M KOH with saturated Ba(OH)₂, CB represents carbon black, and grf represents graphite. In Table 2, materials examined as synthesis starting material include Fe powder. The Fe(II) salts, FeO and FeC₂O₄.Fe₃O₄, and the Fe(III) salts Fe₂O₃, Fe(NO₃)₃, FeCl₃.

In Table 3 materials incorporating both cations and iron have been used as the starting material. These include I=K₂O.1.5Fe₂O₃, II=Li₂O.1.5Fe₂O₃, III=CaO.1.5Fe₂O₃, IV=BaO.1.5Fe₂O₃, and V=2BaO.Fe₂O₃. The latter are produced from stoichiometric mixtures of a carbonate or Ba(OH)₂.8H₂O, and Fe₂O₃(<5 μm, 99+%, Aldrich Chemical), pressing the mixture at 1000 kg, and heating in air at 900° C. for 24 hours produced according to:
2K₂CO₃+3Fe₂O₃→K₂O.1.5Fe₂O₃+2CO₂(gas) (7)
2Li₂CO₃+3Fe₂O₃→Li₂O.1.5Fe₂O₃+2CO₂(gas) (8)
2CaCO₃+3Fe₂O₃→CaO.1.5Fe₂O₃+2CO₂(gas) (9)
2BaCO₃+3Fe₂O₃→BaO.1.5Fe₂O₃+2CO₂(gas) (10)
2Ba(OH)₂.8H₂O+Fe₂O₃→2BaO.Fe₂O₃+10H₂O(gas) (11)

The experiments summarized in Tables 2-4 are provided only by way of example, and are not limiting. It is evident that further variation of the many cell parameters including, but not limited to particle size of the pressed anode powders, anode and electrolyte composition, the separator and cathode type and thicknesses, and other electrolysis conditions can be used to further increase the efficiency, percentage and type of the produced(VI) solid salt. This is exemplified in Table 4, in which synthesis parameters are varied for one starting material, BaO.1.5Fe₂O₃. The BaO.1.5Fe₂O₃ is used as produced, or sorted by particle size through various mesh size sieves (for example, a 390 mesh screen is used to sort the <35 μm particles).

As a continued example, the following experiment was conducted to demonstrate that the electrosynthesis may be scaled up, and that the super-iron purity may be further enhanced. A cell of 4 cm diameter, with 4 times the surface area of the pervious 2 cm diameter electrosynthesis cell, was employed. A 4 cm² cadmium electrode, to be used as the synthesis cathode, and 4 cm² separators, both cut upon removal from an opened AA cylindrical Ni—Cd battery, were used. In one case, the starting material was 125 mAh of BaO.1.5Fe₂O₃, prepared in accord with equation 10. In addition, the starting anode mix contains a 1:2 molar ratio of Ba(OH)₂.8H₂O to BaO.1.5Fe₂O₃, and 25% by weight of carbon black. The anode mix was pressed at 1000 kg into the anode compartment. Then, 0.37 grams of 13.5 M KOH electrolyte was soaked on the anode mix for 12 hours, and subsequently the separator and cathode were pressed into the cell. A 10 mA current was applied to the anode, through the cell for 50 hours. The anode material was removed, and the product contained 82.9% conversion of Fe(III) into solid Fe(VI), such as BaFeO₄, as determined by chromite analysis.

In a second case in the 4 cm diameter synthesis cell, the anode mix contained 50 mAh of 2BaO.Fe₂O₃. The 2BaO.Fe₂O₃ was prepared from 2BaCO₃ and Fe₂O₃, pressing the mixture at 1000 kg, and heating in air at 900° C. for 24 hours. The anode mix also contained 25% by weight KOH, 25% carbon black, as well as 1% Ba(OH)₂.8H₂O and 2% KIO₄. The anode mix was pressed at 1000 kg into the anode compartment. Then, 0.32 grams of 13.5 M KOH electrolyte was soaked on the anode mix for 12 hours, and subsequently the separator and cathode were pressed into the cell. A 50 mA current was applied to the anode, through the cell for 3 hours. The anode material was removed, and the product contained 75.2% conversion of Fe(III) into solid Fe(VI), as determined by chromite analysis.

TABLE 2
Electrochemical synthesis of Fe(III) using various
starting materials under different conditions.

| Starting Fe | anode additive | Conductor | mass electrolyte | Charging | % Fe(VI) |
|---|---|---|---|---|---|
| material in anode | ratio or wt % | wt % anode | added per g anode | current, time | produced |
| Fe(0) | BaO/(1:1) | 40% CB | 0.5 g 13.5 KB | 2 mA, 30 hr | 9.2% |
| Fe | Ba(OH)₂/(1:1) | 40% CB | 0.5 g 13.5 KB | 2 mA, 30 hr | 21.1% |
| Fe(II)O | Ba(OH)₂/(1:3) | 40% CB | 0.5 g 13.5 KB | 2 mA, 30 hr | 25.7% |
| Fe(II)C₂O₄•2H₂O | Ba(OH)₂/(1:1) | 30% CB | 1.5 g 13.5 KB | 2 mA, 60 hr | 58.9% |
| Fe(II)C₂O₄•2H₂O | Ba(OH)₂/(1:1) | 30% CB | 1.5 g 13.5 KB | 2 mA, 60 hr | 38.4% |
| Fe₃O₄ | Ba(OH)₂/(1:3) | 40% CB | 0.5 g 13.5 KB | 2 mA, 30 hr | 31.8% |
| Fe₃O₄ | Ba(OH)₂/(1:3) | 30% CB | 0.5 g 13.5 KB | 2 mA, 30 hr | 39.1% |
| Fe₃O₄ | Ba(OH)₂/(1:3) | 30% CB | 0.75 g 13.5 KB | 2 mA, 40 hr | 42.7% |
| Fe₃O₄ | BaO/(1:1.5) | 30% CB | 0.75 g 13.5 KB | 2 mA, 40 hr | 19.0% |
| Fe(III)₂O₃ | Ba(OH)₂/(1:3) | 30% CB | 0.5 g 13.5 KB | 2 mA, 30 hr | 34.7% |
| Fe₂O₃ | Ba(OH)₂/(1:1) | 30% CB | 0.75 g 13.5 KB | 2 mA, 40 hr | 41.1% |
| Fe₂O₃ | Ba(OH)₂/(1:2) | 30% CB | 0.75 g 13.5 KB | 2 mA, 40 hr | 26.3% |
| Fe(III)(NO₃)₃•9H₂O | Ba(OH)₂/(1:1) | 20% CB | 0.25 g 13.5 KB | 2 mA, 40 hr | 32.3% |
| Fe(III)Cl₃•6H₂O | Ba(OH)₂/(1:1) | 20% CB | 0.25 g 13.5 KB | 2 mA, 40 hr | 34.2% |

TABLE 3
Electrochemical synthesis of Fe(III) using various
starting materials incorporating both cations and iron under
different conditions.

| Starting Fe | anode additive | Conductor | mass electrolyte | Charging | % Fe(VI) |
|---|---|---|---|---|---|
| material in anode | ratio or wt % | wt % anode | added per g anode | current, time | produced |
| I = K₂O•1.5Fe₂O₃ | KOH/(1:1) | 30% CB | 0.5 g 12M KOH | 3 mA, 20 hr | 2.2% |
| II = Li₂O•1.5Fe₂O₃ | LiOH(1:1) | 30% CB | saturated LiOH | 3 mA, 20 hr | 2.2% |
| III = CaO•1.5Fe₂O₃ | Ca(OH)₂(1:2) | 30% CB | saturated Ca(OCl)₂ | 3 mA, 20 hr | 2.6% |
| IV = BaO•1.5Fe₂O₃ | Ba(OH)₂/(1:2) | 30% CB | 0.5 g 13.5 KB | 2 mA, 40 hr | 57.3% |
| V = 2BaO•Fe₂O₃ | no Ba(OH)₂ | 30% CB | 0.5 g 13.5 KB | 2 mA, 40 hr | 62.5% |
| V | 10% Ba(OH)₂ | 30% CB | 0.5 g 13.5 KB | 2 mA, 40 hr | 54.3% |
| V | 15% Ba(OH)₂ | 30% CB | 0.5 g 13.5 KB | 2 mA, 40 hr | 49.8% |
| V | 20% Ba(OH)₂ | 30% CB | 0.5 g 13.5 KB | 2 mA, 40 hr | 44.5% |

TABLE 4
Electrochemical synthesis of Fe(III) using BaO•1.5Fe₂O₃
under different conditions.

| Starting Fe | anode additive | Conductor | mass electrolyte | Charging | % Fe(VI) |
|---|---|---|---|---|---|
| material in anode | ratio or wt % | wt % anode | added per g anode | current, time | produced |
| IV = BaO•1.5Fe₂O₃ | Ba(OH)₂/(1:2) | 40% CB | 0.5 g 13.5 KB | 2 mA, 30 hr | 69.1% |
| IV | Ba(OH)₂/(1:2) | 40% CB | 0.5 g 13.5 KB | 2 mA, 50 hr | 67.7% |
| IV <35 μm particles | Ba(OH)₂/(1:2) | 30% CB | 0.5 g 13.5 KB | 2 mA, 40 hr | 64.5% |
| IV 35-53 μm particles | Ba(OH)₂/(1:2) | 30% CB | 0.5 g 13.5 KB | 2 mA, 40 hr | 62.0% |
| IV 53-73 μm particles | Ba(OH)₂/(1:2) | 30% CB | 0.5 g 13.5 KB | 2 mA, 40 hr | 57.1% |
| IV >73 μm particles | Ba(OH)₂/(1:2) | 30% CB | 0.5 g 13.5 KB | 2 mA, 40 hr | 54.7% |
| IV | BaO(1:2)& 10%CsOH | 40% CB | 0.5 g 13.5 KB | 2 mA, 30 hr | 65.6% |
| IV | BaO(1:2) | 40% CB | 1 g 13.5 K | 2 mA, 30 hr | 58.2% |
| IV | BaO(1:2) | 40% CB | 0.75 g 13.5 KB | 2 mA, 30 hr | 61.6% |
| IV | BaO(1:2) | 40% CB | 0.5 g 13.5 KB | 2 mA, 30 hr | 66.2% |
| IV | BaO(1:2) | 40% CB | 0.25 g 13.5 KB | 2 mA, 30 hr | 41.5% |
| IV | BaO(1:2)&10% KOH | 40% CB | 0.5 g 13.5M KOH | 2 mA, 30 hr | 59.3% |
| IV | BaO(1:2) | 40% CB | 0.5 g 13.5M KOH | 2 mA, 30 hr | 61.9% |
| IV | BaO(1:2) | 30% CB | 0.5 g 13.5M KOH | 2 mA, 30 hr | 52.8% |
| IV | BaO(1:2) | 10% CB | 0.5 g 12M KOH | 2 mA, 30 hr | 16.0% |
| IV | BaO(1:2) | 20% CB | 0.5 g 12M KOH | 2 mA, 30 hr | 35.3% |
| IV | BaO(1:2) | 30% CB | 0.5 g 12M KOH | 2 mA, 30 hr | 48.3% |
| IV | BaO(1:2) | 40% CB | 0.5 g 12M KOH | 2 mA, 30 hr | 56.8% |
| IV | BaO(1:2) | 50% CB | 0.5 g 12M KOH | 2 mA, 30 hr | 54.2% |
| IV | BaO(1:2) | 60% CB | 0.5 g 12M KOH | 2 mA, 30 hr | 50.7% |
| TV | BaO(1:2) | 30% CB | 0.5 g 10M KOH | 2 mA, 30 hr | 25.9% |
| IV | BaO(1:2) | 30% CB | 0.5 g 8M KOH | 2 mA, 30 hr | 12.3% |
| IV | BaO(1:2) | 30% CB | 0.5 g 6M KOH | 2 mA, 30 hr | 10.6% |
| IV | BaO(1:2) | 30% CB | 0.5 g 12M KOH | 2 mA, 60 hr | 49.3% |
| IV | BaO(1:2) | 30% CB | 0.5 g 12M KOH | 2 mA, 20 hr | 44.6% |
| IV | BaO(1:2) | 30% CB | 0.5 g 12M KOH | 2 mA, 10 hr | 31.0% |
| IV | BaO(1:2) | 30% CB | 0.5 g 12M KOH | 2 mA, 5 hr | 25.2% |
| IV | BaO(1:2) | 30% CB | 0.5 g 12M KOH | 3 mA, 20 hr | 49.1% |
| IV | BaO(1:2) | 30% CB | 0.5 g 12M KOH | 1 mA, 60 hr | 31.9% |
| IV | BaO(1:2) | 30% CB | 0.5 g 12M KOH | 0.5 mA, 120 hr | 26.9% |
| IV | BaO(1:2) | 30% CB | 0.5 g 12M KOH | 10 mA, 6 hr | 43.0% |
| IV | Ba(OH)₂(1:1) | 30% grf | 0.5 g 12M KOH | 3 mA, 20 hr | 12.7% |
| IV | no Ba(OH)₂ | 30% grf | saturated Ba(OH)₂ | 3 mA, 20 hr | 8.4% |

### EXAMPLE 3

An experiment was carried out, the object being to produce using a non aqueous electrolyte, solid Fe(VI) salt using an electrochemical cell as diagramtically illustrated in FIG. 1. The cell configuration consisted of a 2.3 cm diameter button cell comprised of an upper (cathode) section, pressing onto a mid (separator) section, pressing onto a lower (anode) section. The upper section of the electrochemical cell configuration comprises an upper inverted metal dish plate (the cathode case) pressing onto a Li-ion electrode, removed from a discharged commercial Li-ion battery, and determined in accord with equation 4, to be in coulombic excess of the iron starting material. The mid section consists of separator materials removed from commercial Li-ion batteries, and is surrounded by a washer to prevent direct contact or electrical shorting of the upper and lower section. An electrolyte was added to the separator and anode mix. The electrolyte was comprised of 350 mg of 1M LiPF₆ in a 1:1 ratio EC to DEC (ethylene carbonate to dimethylethylene carbonate). The lower section consists of a mixed material (53.9 mg Fe₂O₃, 32.4 mg LiOH, 86.5 mg LiClO₄, and 57.3 mg carbon black) pressed into a bottom metal dish plate, the anode case. An oxidizing current of 1 mA was applied to the anode using a constant current power supply connected through the cell for 28 hours. The cell was then open, and the solid iron material was removed. The percentage of the original iron containing material that was converted to solid Fe(VI) salt was determined by the chromite method, equation 6, and was analyzed at 65.3% conversion of Fe(III) to Fe(VI), such as Li₂FeO₄.

1. A process for preparing Fe(VI) salts which comprising two half-cells which are in an electrochemical contact with one another through an electrically neutral ionic conductor, wherein one of said half-cells comprises a cathode and the other half-cell comprises at least 1% of weight of an iron containing material, wherein a power supply is used to oxidize the iron containing material to a solid Fe(VI) salt.

2. The process according to claim 1, wherein said iron containing material is a solid or dissolved Fe(III) salt.

3. The process according to claim 1, wherein said iron containing material is a solid or dissolved Fe(II) salt.

4. The process according to claim 1, wherein said iron containing material is iron metal, Fe(0).

5. The process according to claim 2 or 3, wherein said salt is an oxide or a hydroxide or contains the anions, selected from the group consisting of acetates, acetylsalicylates, alumminates, aluminum hudrides, amides, antomonides, arsenates, azides, benzoates, borates, bromides, bromates, carbides, carbonates, chlorates, perchlorates, chlorides, hypochlorites, chlorites, dithionate, chloroplatinates, chromates, citrates, fluorides, fluosilicates, fluosulfonates, formates, gallium hydrides, gallium nitrides, germanates, hydrides, iodates, iodides, periodate, laurates, manganates, malonates, permanganates, molybdates, myristates, nitrates, nitrides, nitrites, oxalates, palmitates, phosphates, salicylates, selenates, selenides, silicates, silicides, stearates, succinates, sulfates, sulfides, sulfites, tartrates, thiocyanates, thionates, tungstates, halides, or chalcogenides.

6. The process according to claim 2 or 3, wherein said salt includes a cation, selected from the group consisting of the alkali cations, H⁺, the alkali earth cations, transition metal cations, or containing cations of group III, group IV and group V or ammonium or organic ammonium cations.

7. The process according to claims 1 to 4, wherein said electrically neutral ionic conductor is an aqueous solution.

8. The process according to claims 1 to 4, wherein said electrically neutral ionic conductor is a nonaqueous solution.

9. The process according to claims 1 to 4, wherein said electrically neutral ionic conductor is a conductive polymer.

10. The process according to claims 1 or 2, wherein said electrically neutral ionic conductor is a solid ionic conductor.

11. The process according to claims 1 to 4, wherein said electrically neutral ionic conductor is a molten salt.

12. The process according to claims 7 to 11, wherein said neutral ionic conductor contains a dissolved salt.

13. The process according to claims 7 to 9, wherein said neutral ionic conductor contains a dissolved liquid.

14. The process according to claim 13, wherein said dissolved liquid is an organic solvent.

15. The process according to claims 7-11, wherein said neutral ionic conductor contains the concentration of up to saturation in hydroxide ions.

16. The process according to claim 12, wherein said dissolved salt is an iron salt in a concentration of up to saturation.

17. The process according to claim 16, wherein said iron salt an Fe(VI) salt.

18. The process according to claim 16, wherein said iron salt an Fe(III) salt.

19. The process according to claim 16, wherein said iron salt an Fe(II) salt.

20. The process according to claim 12, wherein said dissolved salt is an oxide or a hydroxide or contains the anions, selected from the group consisting of acetates, acetylsalicylates, alumminates, aluminum hudrides, amides, antomonides, arsenates, azides, benzoates, borates, bromides, bromates, carbides, carbonates, chlorates, perchlorates, chlorides, hypochlorites, chlorites, dithionate, chloroplatinates, chromates, citrates, fluorides, fluosilicates, fluosulfonates, formates, gallium hydrides, gallium nitrides, germanates, hydrides, iodates, iodides, periodate, laurates, manganates, malonates, permanganates, molybdates, myristates, nitrates, nitrides, nitrites, oxalates, palmitates, phosphates, salicylates, selenates, selenides, silicates, silicides, stearates, succinates, sulfates, sulfides, sulfites, tartrates, thiocyanates, thionates, tungstates, halides, or chalcogenides.

21. The process according to claim 12, wherein said dissolved salt includes a cation, selected from the group consisting of the alkali cations, H⁺, the alkali earth cations, transition metal cations, or containing cations of group III, group IV and group V or ammonium or organic ammonium cations.

22. The process according to claims 1 to 4, further characterized in that said iron containing material is in contact with a conductive material.

23. The process according to claim 22, wherein said conductive material is selected from graphite, carbon black and a metal.

24. The process according to claim 22, wherein said iron containing material-conductive material comprises a mixed pressed powder.

25. The process according to claim 22, wherein said iron containing material-conductive material comprises a planar surface or a wire.

26. The process according to claim 22, wherein said iron containing material-conductive material comprises a porous substrate or grid.

27. The process according to claims 1 to 4 further comprising means to impede transfer of chemically reactive species between said anode and said other half cell.

28. The process according to claim 27, wherein said means is a non conductive separator configured with open channels, grids or pores.

29. The process according to claim 26 in which said means to impede transfer of chemically reactive species comprises a membrane positioned to separate said half cells.

30. The process according to claim 1, wherein said cathode includes a non metal inorganic salt capable of being reduced.

31. The process according to claim 1, wherein said cathode includes a metal inorganic salt capable of being reduced.

32. The process according to claim 1, wherein said cathode includes an organic compound capable of being reduced.

33. The process according to claim 32, wherein said organic compound is selected from the group consisting of aromatic and non-aromatic compounds.

34. The process according to claims 1, further characterized in that said neutral ionic conductor contains an added enhancing material to modify the Fe(VI) salt production.

35. The process according to claims 1 to 4, further characterized in that said iron containing material contains an added enhancing material to modify the Fe(VI) salt production.

36. The process according to claim 34 or 35, wherein said enhancing material is a Ba(II) compounds.

37. The process according to claim 34 or 35, wherein said enhancing material is an oxygen containing compound, such as an oxide or hydroxide compound.

38. The process according to claim 34 or 35, wherein said enhancing material is an indium containing compound.

39. The battery according to claim 1, wherein said enhancing material is a manganese containing compound.

40. The process according to claim 10, wherein said charging voltage altering material, is a lithium containing compound.

41. The process according to claim 34 or 35, wherein said enhancing material is a tin containing compound.

42. The process according to claim 34 or 35, wherein said enhancing material is a tungsten containing compound.

43. The process according to claim 10, wherein said enhancing material is a cobalt containing compound.

44. The process according to claim 1, wherein said cathode includes an oxide or a hydroxide or contains the anions, selected from the group consisting of chalcogenide, chromate, molybdate, silicate, malonate, succinate, tartrate, selenate, sulfate, sulfite, halide, nitrate, bromate, chlorate, perchlorate, acetate, oxalate, carbonate, benzoate, hypochlorite, chlorite, dithionate, formate, iodate, periodate, carbonates, acetates, acetylsalicylates, alumminates, aluminum hudrides, amides, antomonides, arsenates, azides, benzoates, borates, bromides, carbides, chlorates, chlorides, chloroplatinates, chromates, citrates, fluorides, fluosilicates, fluosulfonates, gallium hydrides, gallium nitrides, germanates, hydrides, iodides, laurates, manganates, permanganates, molybdates, myristates, nitrates, nitrides, nitrites, oxalates, palmitates, phosphates, salicylates, selenides, silicates, suicides, stearates, sulfates, sulfides, sulfites, tartrates, thiocyanates, thionates, or tungstates.

45. The process according to claim 1, wherein said cathode includes a cation, selected from the group consisting of the alkali cations, H, the alkali earth cations, transition metal cations, or containing cations of group III, group IV and group V or ammonium or organic ammonium cations, or a lithium cation and a material capable of incorporating the lithium ions, consisting of a carbon based material, or a tin based material, or a lithium intercalating material.

46. The process substantially as described in the specifications and in any one of claims 1 to 45.
